(19) United States
(12) Patent Application Publication
(10) Pub. No.: US 2012/0200814 A1
(43) Pub. Date: Aug. 9, 2012

(54) LIQUID CRYSTAL DISPLAY PANEL, PROCESS FOR PRODUCTION OF LIQUID CRYSTAL DISPLAY PANEL, AND LIQUID CRYSTAL DISPLAY DEVICE

(75) Inventor: Kenji Miyamoto, Osaka (JP)

(73) Assignee: SHARP KABUSHIKI KAISHA, Osaka (JP)

(21) Appl. No.: 13/501,857

(22) PCT Filed: Jun. 10, 2010
(86) PCT No.: PCT/JP2010/059867

§ 371 Date: Apr. 13, 2012

(30) Foreign Application Priority Data
Oct. 14, 2009 (JP) 2009-237380

(51) Int. Cl. G02F 1/1335; B29C 65/14

(52) U.S. Cl. 349/106; 349/110; 156/275.5

(57) ABSTRACT

On an opposite substrate (2) of a liquid crystal display panel (1), a light-shielding film (3) is formed. The light-shielding film (3) has a transmittance of 20% or more at a wavelength in a wavelength range of not shorter than 350 nm and having shorter than 380 nm and has a transmittance of 50% or less at all wavelengths in a wavelength range of 430 nm and longer and 700 nm and shorter when the transmittance of the opposite substrate (2) is defined as 100%. In the liquid crystal display panel (1), a layer underneath the light-shielding film (3) can be sufficiently irradiated with a UV light even when the UV light is radiated from a substrate side on which the light-shielding film (3) is formed.

### TECHNICAL FIELD

The present invention relates to a liquid crystal display panel equipped with a light-shielding film, to a method for manufacturing the liquid crystal display panel, and to a liquid crystal display device.

### BACKGROUND ART

In recent years, liquid crystal display devices have been in wide use as a display device for mobile information devices such as mobile phones, PDAs (Personal Digital Assistants), and MP3 players to achieve an energy efficient, thin, and lightweight device or the like.

Among them, much attention has been given to light-scattering type liquid crystal display devices, which have a high efficiency of light usage because they do not require a polarizing plate and which are capable of switching a scattering state and a transparent state depending on the existence of electric field application to a liquid crystal layer, and the above-mentioned light-scattering type liquid crystal display devices especially have been often used in memory liquid crystal or the like.

The above-mentioned light-scattering type liquid crystal display device is provided with a liquid crystal layer containing polymers, which are monomers that have been cured by UV light (ultraviolet light) irradiation, such as Polymer Network Liquid Crystal (PNLC) and Polymer Dispersed Liquid Crystal (PDLC).

In view of shortening takt time, a UV-curable sealing member rather than a heat-curable sealing member is mainly used as a sealing member for bonding two substrates provided in a liquid crystal display device, in general, and for sandwiching the liquid crystal layer between the above-mentioned substrates.

The above-mentioned liquid crystal layer, which contains monomers curable by UV light irradiation, and the UV-curable sealing member are cured by UV light irradiation in a state where the two substrates are bonded together, that is, a state of a liquid crystal display panel.

Meanwhile, a configuration of including a black matrix for improving the appearance and contrast is common for liquid crystal display devices.

Explained below with reference to FIGS. 13 and 14 is a difference between how the above-described liquid crystal layer, which contains monomers that are curable by UV light irradiation, is cured in a liquid crystal display panel provided with no black matrix, and how the same curing takes place in a liquid crystal display panel provided with a black matrix.

FIG. 13 shows a schematic configuration of a liquid crystal display panel 100 provided with no black matrix, and shows how a liquid crystal layer, which is provided in the liquid crystal display panel 100 and which contains monomers 107 curable by UV light irradiation, is cured by UV light irradiation.

The liquid crystal display panel 100 is provided with an upper transparent insulating substrate 101 and a lower transparent insulating substrate 102. A common electrode 103a made of a transparent conductive material is formed on an almost entire surface of a surface of the upper transparent insulating substrate 101 that is facing the lower transparent insulating substrate 102.

Meanwhile, a TFT element layer 104 in which a gate electrode layer, a gate insulating layer, a semiconductor layer, and a source/drain electrode layer are sequentially laminated is formed on a surface of the lower transparent insulating substrate 102 that is facing the upper transparent insulating substrate 101.

On the TFT element layer 104, a pixel electrode 103b that is electrically connected to the drain electrode of the TFT element layer 104 and that is made of a transparent conductive material is formed in each pixel.

As shown in the figure, a UV-curable sealing member 105 is formed in the outer periphery of the liquid crystal display panel 100, and the two substrates 101 and 102 provided in the liquid crystal display panel 100 are bonded together by the sealing member 105.

A liquid crystal layer containing liquid crystal molecules 106 and the monomers 107, which are curable by UV light irradiation, is formed in the inside of an area where the sealing member 105 is formed such that the liquid crystal layer is sandwiched between the above-mentioned substrates 101 and 102.

In the liquid crystal display panel 100 without a black matrix, as shown in the figure, UV light irradiated from the opposite side to a surface of the upper transparent insulating substrate 101 facing the lower transparent insulating substrate 102 illuminates the liquid crystal layer in an approximately even manner, and therefore, by adjusting the amount of the UV light, the monomers 107 in the liquid crystal layer can be almost completely changed to polymers 108.

Meanwhile, in order to improve the appearance and contrast of the liquid crystal display panel 100 shown in FIG. 13, a liquid crystal display panel 100a shown in FIG. 14 has a configuration in which a black matrix 109 made of carbon black, which has almost no transmittance in the UV light range, is formed on a surface of the upper transparent insulating substrate 101 facing the lower transparent insulating substrate 102.

Because of such a configuration, as shown in the figure, UV light irradiated from the opposite side to the surface of the upper transparent insulating substrate 101 facing the lower transparent insulating substrate 102 hardly illuminates an area below the area where the black matrix 109 is formed, that is, an area R1 in the liquid crystal layer shadowed by the black matrix 109.

Consequently, the area R1 in the liquid crystal layer contains the liquid crystal molecules 106 and uncured monomers 107.

Such uncured monomers 107 have little impact on the initial display condition of the liquid crystal display panel 100a. However, after a long term aging, a problem occurs such that the uncured monomers 107 existing in the area R1 enter the area R2, above which there is provided no black matrix 109 and which is a display region in a strict sense, in the liquid crystal layer, and this causes display anomalies.

A detailed description was made with respect to the liquid crystal layer containing monomers curable by UV light irradiation as an example, but a similar problem occurs to the UV curable sealing member 105 that is formed below the area where the black matrix 109 is formed.

Here, in order to solve these problems, it is possible to consider irradiating UV light from the lower transparent insulating substrate 102 side on which the black matrix 109 is absent, however, in the liquid crystal display panel 100a, the lower transparent insulating substrate 102 side is also provided with the above-described TFT element layer 104 that blocks light in the UV light range, and therefore, an area that is hardly irradiated with UV light is still created in this case.

Furthermore, although not shown in the figure, in a reflective liquid crystal display panel, a reflective member is typically formed on the insulating substrate that is arranged opposite to the insulating substrate provided with the black matrix, and therefore, it is difficult to irradiate UV light from the side of the insulating substrate that is arranged opposite to the insulating substrate provided with the black matrix.

There have been attempts in the past to suppress an occurrence of the above-described area that is irradiated with no UV light in a liquid crystal display panel.

For example, Patent Document 1 describes a method for manufacturing a polymer-dispersed liquid crystal panel that is capable of curing a resin below the black matrix.

FIG. 15 is a diagram for explaining the method for manufacturing the polymer-dispersed liquid crystal panel that is capable of curing a resin below the black matrix.

As shown in the figure, a mixed solution (liquid crystal layer) 213, which contains a mixture of liquid crystal and uncured UV resin, is injected to an area between an array substrate 212 and an opposite substrate 211.

A diffusion plate 218 made of an opal glass is attached to a surface of the array substrate 212 through ethylene glycol 220a. The surface opposite to this surface is facing the opposite substrate 211.

When the array substrate 212 and the diffusion plate 218 are optically coupled as described above, refraction of light does not occur between the two substrates, and therefore, light scattered at the diffusion plate 218 travels straight to the mixed solution (liquid crystal layer) 213.

An opposite electrode 214 is formed on a surface of the opposite substrate 211 facing the array substrate 212, and pixel electrodes 215 are formed on a surface of the array substrate 212 facing the opposite substrate 211.

When UV light 219 is radiated from the diffusion plate 218 side, the UV light 219 is scattered inside the diffusion plate 218, and the scattered light reaches the mixed solution 213.

A part of the UV light 219 also travels approximately parallel to the opposite substrate 211, and illuminates the mixed solution 213 that is sandwiched between source signal lines 217 and a black matrix 216.

Patent Document 1 describes that because the mixed solution 213 is irradiated with the UV light 219 as described above, uncured UV resin in the mixed solution 213 can be cured, and the mixed solution 213 can be phase-separated into a resin component and a liquid crystal component.

It is also described that by detaching the diffusion plate 218 after the uncured UV resin in the mixed solution 213 has been cured as described above, it is possible to achieve a polymer-dispersed liquid crystal panel 210 that includes the mixed solution (liquid crystal layer) 213 containing almost no uncured UV resin and that shows high contrast.

### RELATED ART DOCUMENTS

### Patent Documents

Patent Document 1: Japanese Patent Application Laid-Open Publication H7-175047 (published on Jul. 14, 1995)

### SUMMARY OF THE INVENTION

### Problems to be Solved by the Invention

However, in the above-mentioned configuration of Patent Document 1, the UV light 219 is scattered inside the diffusion plate 218 and the mixed solution (liquid crystal layer) 213 is irradiated with the scattered light. Here, the scattered light is not likely to illuminate an area shadowed by the source signal lines 217. Therefore, the above-mentioned configuration has a problem such that the mixed solution 213 sandwiched between the source signal lines 217 and the black matrix 216 is not sufficiently irradiated with the scattered light, and thereby, uncured UV resin is left in this area.

There is also a problem such that the mixed solution 213 in the frame area of the polymer-dispersed liquid crystal panel 210 is irradiated with a further decreased amount of the scattered light because the frame area is an edge portion of the polymer-dispersed liquid crystal panel 210.

The present invention was devised in view of the above-mentioned problems, and an object of the present invention is to provide a liquid crystal display panel capable of sufficiently irradiating a layer below the light-shielding film with UV light of a certain wavelength even when the UV light is irradiated from a substrate side on which the light-shielding film is formed, and a method for manufacturing the above-mentioned liquid crystal display panel, and provide a liquid crystal display device.

### Means for Solving the Problems

In order to solve the above-mentioned problems, a liquid crystal display panel of the present invention includes: a first insulating substrate; a second insulating substrate disposed so as to face the first insulating substrate; and a light-shielding body that blocks light from entering at least a part of a non-display region of the liquid crystal display panel, the light-shielding body being formed on either the first insulating substrate or the second insulating substrate that faces the first insulating substrate or the second insulating substrate, wherein an insulating substrate on which the light-shielding body is formed, which is either the first insulating substrate or the second insulating substrate, is at least a transparent insulating substrate, and wherein when a transmittance of the transparent insulating substrate is defined as 100%, the light-shielding body has a transmittance of 20% or more at a wavelength in a wavelength range of 350 nm and longer and shorter than 380 nm, and the light-shielding body has a transmittance of 50% or less at all wavelengths within a wavelength range of 430 nm and longer and 700 nm and shorter.

In order to solve the above-mentioned problems, the present invention provides a method for manufacturing a liquid crystal display panel that includes: a transparent insulating substrate; an insulating substrate disposed so as to face the transparent insulating substrate; a sealing member for bonding the transparent insulating substrate and the insulating substrate; and a liquid crystal material, the method including forming a light-shielding body on a surface of the transparent insulating substrate facing the insulating substrate, the light-shielding body blocking light from entering at least a part of a non-display region of the liquid crystal display panel, wherein when a transmittance of the transparent insulating substrate is defined as 100%, it has a transmittance of 20% or more at a wavelength within a wavelength range of 350nm and longer and shorter than 380 nm, and a transmittance of 50% or less at all wavelengths within a wavelength range of 430 nm and longer and 700 nm and shorter; forming the sealing member on a surface of the transparent insulating substrate facing the insulating substrate, or on a surface of the insulating substrate facing the transparent insulating substrate, and then bonding the transparent insulating substrate and the insulating substrate together; injecting the liquid crystal material, which contains a monomer mixture that is cured by irradiation of light in a wavelength range of 350 nm or longer and shorter than 380 nm, into an area between the transparent insulating substrate and the insulating substrate that have been bonded; and irradiating the liquid crystal material with UV light through the transparent insulating substrate from a side opposite to a surface of the transparent insulating substrate facing the insulating substrate.

According to the above-mentioned configuration, a light-shielding body, which blocks light from entering at least a part of a non-display region of the liquid crystal display panel and which has a transmittance of 20% or more at a wavelength within a wavelength range of 350 nm or longer and shorter than 380 nm, is formed on either the first insulating substrate or the second insulating substrate provided in the liquid crystal display panel.

Therefore, even when UV light is irradiated from the insulating substrate side on which the light-shielding body is formed, UV light at a wavelength within a wavelength range of 350 nm or longer and shorter than 380 nm can transmit through an area where the light-shielding body is formed.

It is said that light in the wavelength range of 350 nm or longer and shorter than 380 nm is the light in the most effective wavelength range for curing the monomer mixture that is curable by UV light irradiation.

Accordingly, even when a liquid crystal material, which contains a monomer mixture that is curable by UV light irradiation, and UV-curable sealing member are provided in the above-mentioned liquid crystal display panel, and the liquid crystal material and the sealing member are arranged below the area where the light-shielding body is formed, for example, it is possible to sufficiently cure the liquid crystal material and the sealing member by irradiating UV light from the insulating substrate side on which the light-shielding body is formed.

In other words, even when UV light is irradiated from the insulating substrate side on which the light-shielding body is formed, the liquid crystal material and the sealing member can be sufficiently irradiated with the UV light at the above-mentioned certain wavelength, and therefore, the liquid crystal material and the sealing member can be cured without leaving an uncured component. As a result, it is possible to achieve a liquid crystal display panel that is capable of maintaining reliability for a long period of time and a method for manufacturing the liquid crystal display panel.

Meanwhile, light in a wavelength range of shorter than 430 nm and light in a wavelength range longer than 700 nm are relatively difficult for the human eye to sense, and therefore, even though the light-shielding body has a slightly high transmittance of light in such wavelength ranges, it does not affect the display quality of the liquid crystal display panel significantly.

According to the above-mentioned configuration, the light-shielding body, which blocks light from entering at least a part of a non-display region of the liquid crystal display panel, has a transmittance of 50% or less for light in a wavelength range of 430 to 700 nm, which is the light in a wavelength range easily sensed by the human eye.

Accordingly, it is possible to suppress leakage of light in a wavelength range of 430 to 700 nm, which is the light in a wavelength range easily sensed by the human eye, from the non-display region of the liquid crystal display panel, and as a result, a liquid crystal display panel with improved appearance and contrast, and a method for manufacturing such a liquid crystal display panel can be realized.

As discussed above, according to the above-mentioned configuration, it is possible to achieve a liquid crystal display panel with improved appearance and contrast that is capable of maintaining reliability for a long period of time, and to also achieve a method for manufacturing such a liquid crystal display panel.

Note that the non-display region in the liquid crystal display panel refers to an area that cannot perform an intended display in the liquid crystal material such as an area in which wiring is formed or an area in which the sealing member is formed, or an area where the liquid crystal material does not exist in the liquid crystal display panel.

In order to solve the above-mentioned problems, the present invention provides a method for manufacturing a liquid crystal display panel including a transparent insulating substrate, an insulating substrate disposed so as to face the transparent insulating substrate, a sealing member for bonding the transparent insulating substrate and the insulating substrate, and a liquid crystal material, the method including forming a light-shielding body on a surface of the transparent insulating substrate facing the insulating substrate, and this light-shielding body blocks light from entering at least a part of a non-display region of the liquid crystal display panel, and when a transmittance of the transparent insulating substrate is defined as 100%, the light-shielding body has a transmittance of 20% or more at a wavelength within a wavelength range of 350 nm or longer and shorter than 380 nm, and a transmittance of 50% or less at all wavelengths within a wavelength range of 430 to 700 nm; forming the sealing member, which is cured by irradiation of light at a wavelength range of 350 nm or longer and shorter than 380 nm, on a surface of the transparent insulating substrate facing the insulating substrate, or on a surface of the insulating substrate facing the transparent insulating substrate; dripping the liquid crystal material, which contains a monomer mixture that is cured by irradiation of light at a wavelength range of 350 nm or longer and shorter than 380 nm, in an area enclosed by the sealing member on a surface on which the sealing member is formed; bonding the transparent insulating substrate and the insulating substrate together; and irradiating the liquid crystal material and sealing member with UV light through the transparent insulating substrate from a side opposite to a surface of the transparent insulating substrate facing the insulating substrate.

According to the above-mentioned method, the liquid crystal material is injected between the transparent insulating substrate and the insulating substrate by the One Drop Filling method (ODF method). Therefore, the time for injecting the liquid crystal material can be substantially shortened, and thereby, it is possible to significantly improve the productivity of a liquid crystal display panel with improved appearance and contrast that is capable of maintaining reliability for a long period of time.

In order to solve the above-mentioned problems, a liquid crystal display device of the present invention includes the above-mentioned liquid crystal display panel in which a substrate on which the light-shielding body is absent is also a transparent insulating substrate, and a backlight for irradiating the liquid crystal display panel with light.

According to the above-mentioned configuration, it is possible to achieve a transmissive liquid crystal display device with improved appearance and contrast that is capable of maintaining reliability for a long period of time.

In order to solve the above-mentioned problems, a liquid crystal display device of the present invention includes the above-mentioned liquid crystal display panel, wherein a light reflective member for reflecting light or a light absorption member for absorbing light is formed on a substrate on which the light-shielding body is absent, which is either the first insulating substrate or the second insulating substrate.

According to the above-mentioned configuration, it is possible to achieve a reflective liquid crystal display device with improved appearance and contrast that is capable of maintaining reliability for a long period of time.

### Effects of the Invention

As described above, a liquid crystal display panel of the present invention includes: a first insulating substrate; and a second insulating substrate disposed so as to face the first insulating substrate, wherein a light-shielding body, which blocks light from entering at least a part of a non-display region of the liquid crystal display panel, is formed on a surface, facing the first insulating substrate or the second insulating substrate, of either the first insulating substrate or the second insulating substrate, wherein an insulating substrate on which the light-shielding body is formed, which is either the first insulating substrate or the second insulating substrate, is at least a transparent insulating substrate, and wherein when a transmittance of the transparent insulating substrate is defined as 100%, the light-shielding body has a transmittance of 20% or more at a wavelength within a wavelength range of 350 nm or longer and shorter than 380 nm, and the light-shielding body has a transmittance of 50% or less at all wavelengths within a wavelength range of 430 to 700 nm.

A liquid crystal display device of the present invention includes the above-mentioned liquid crystal display panel in a manner described above.

As described above, a liquid crystal display device of the present invention has a configuration of including the above-mentioned liquid crystal display panel in which a light reflective member for reflecting light or a light absorption member for absorbing light is formed on a substrate on which the light-shielding body is absent, which is either the first insulating substrate or the second insulating substrate.

As described above, the present invention provides a method for manufacturing a liquid crystal display panel including: a transparent insulating substrate; an insulating substrate disposed so as to face the transparent insulating substrate; a sealing member for bonding the transparent insulating substrate and the insulating substrate; and a liquid crystal material, the method including: forming a light-shielding body on a surface of the transparent insulating substrate facing the insulating substrate, the light-shielding body blocking light from entering at least a part of a non-display region of the liquid crystal display panel, wherein when a transmittance of the transparent insulating substrate is defined as 100%, the light-shielding body has a transmittance of 20% or more at a wavelength within a wavelength range of 350 nm and longer and shorter than 380 nm, and a transmittance of 50% or less at all wavelengths within a wavelength range of 430 nm and longer and 700 nm and shorter; forming the sealing member, which is cured by irradiation of light at a wavelength range of 350 nm or longer and shorter than 380 nm, on a surface of the transparent insulating substrate facing the insulating substrate, or on a surface of the insulating substrate facing the transparent insulating substrate; dripping the liquid crystal material, which contains a monomer mixture that is cured by irradiation of light at a wavelength range of 350 nm or longer and shorter than 380 nm, in an area enclosed by the sealing member and on a surface on which the sealing member is formed; bonding the transparent insulating substrate and the insulating substrate together; and irradiating the liquid crystal material and sealing member with UV light through the transparent insulating substrate from a side opposite to a surface of the transparent insulating substrate facing the insulating substrate.

As described above, the present invention provides a method for manufacturing a liquid crystal display panel including a transparent insulating substrate, an insulating substrate disposed so as to face the transparent insulating substrate, a sealing member for bonding the transparent insulating substrate and the insulating substrate, and a liquid crystal material, the method including forming a light-shielding body on a surface of the transparent insulating substrate facing the insulating substrate, and this light-shielding body blocks light from entering at least a part of a non-display region of the liquid crystal display panel, and when a transmittance of the transparent insulating substrate is defined as 100%, the light-shielding body has a transmittance of 20% or more at a wavelength within a wavelength range of 350 nm or longer and shorter than 380 nm, and a transmittance of 50% or less at all wavelengths within a wavelength range of 430 to 700 nm; forming the sealing member on a surface of the transparent insulating substrate facing the insulating substrate, or on a surface of the insulating substrate facing the transparent insulating substrate, and then bonding the transparent insulating substrate and the insulating substrate together; injecting the liquid crystal material, which contains a monomer mixture that is cured by irradiation of light in a wavelength range of 350 nm or longer and shorter than 380 nm, into an area between the transparent insulating substrate and the insulating substrate that have been bonded; and irradiating the liquid crystal material with UV light from a side opposite to a surface of the transparent insulating substrate facing the insulating substrate.

Therefore, it is possible to achieve a liquid crystal display panel in which a layer below the light-shielding film can be sufficiently irradiated with UV light at a certain wavelength even when the UV light is irradiated from the substrate side on which the light-shielding film is formed, a method for manufacturing the liquid crystal display panel, and such a liquid crystal display device.

### BRIEF DESCRIPTION OF THE DRAWINGS

FIG. 1 is a diagram showing a schematic configuration of a liquid crystal display panel according to Embodiment 1 of the present invention, and shows a curing process of a light-scattering type liquid crystal material, which contains a monomer mixture curable by UV light irradiation, provided in the above-mentioned liquid crystal display panel.

FIG. 2 is a diagram showing a transmittance in the UV light range and a transmittance in the visible light range of an ideal light-shielding film and those of an actual light-shielding film in a liquid crystal display panel according to Embodiment 1 of the present invention.

FIG. 3 is a diagram showing an example of a light-shielding film provided in a liquid crystal display panel according to Embodiment 1 of the present invention.

FIG. 4 is a diagram showing an example of a shape of a light-shielding film provided in a liquid crystal display panel according to Embodiment 1 of the present invention.

FIG. 5 is a diagram showing an example of another shape of the light-shielding film provided in a liquid crystal display panel according to Embodiment 1 of the present invention.

FIG. 6 is a diagram showing a process for manufacturing a liquid crystal display panel and a liquid crystal display device according to Embodiment 1 of the present invention in which a light-scattering type liquid crystal material is injected by vacuum injection.

FIG. 7 is a diagram showing a process for manufacturing a liquid crystal display panel and a liquid crystal display device according to Embodiment 1 of the present invention in which a light-scattering type liquid crystal material is injected by the One Drop Filling method (ODF method).

FIG. 8 is a diagram showing a modification example of a liquid crystal display panel according to Embodiment 1 of the present invention provided in a reflective liquid crystal display device.

FIG. 9 is a diagram showing another modification example of a liquid crystal display panel according to Embodiment 1 of the present invention provided in a reflective liquid crystal display device.

FIG. 10 is a diagram showing an example of a liquid crystal display panel according to Embodiment 1 of the present invention provided in a transmissive liquid crystal display device of the present invention.

FIG. 11 is a diagram showing a transmittance in the UV light range and a transmittance in the visible light range of a dielectric multilayered film provided in a liquid crystal display panel according to another embodiment of the present invention.

FIG. 12 is a diagram showing a transmittance in the UV light range and a transmittance in the visible light range of an organic film containing NiO and Co₂O₃ provided in a liquid crystal display panel according to yet another embodiment of the present invention.

FIG. 13 is a diagram showing a schematic configuration of a conventional liquid crystal display panel equipped with no black matrix, and how a liquid crystal layer, which contains monomers curable by UV light irradiation, provided in the liquid crystal display panel is cured by UV light irradiation.

FIG. 14 is a diagram showing a liquid crystal display panel in FIG. 13 provided with a black matrix.

FIG. 15 is a diagram for explaining a method for manufacturing a conventional polymer-dispersed liquid crystal panel in which a resin below a black matrix can be cured.

### DETAILED DESCRIPTION OF EMBODIMENTS

Below, embodiments of the present invention are described in detail with reference to figures. Dimensions, materials, shapes, relative positions and the like of configuring members mentioned in the description of embodiments are only examples, and the scope of this invention should not be interpreted in a limited manner by them.

### Embodiment 1

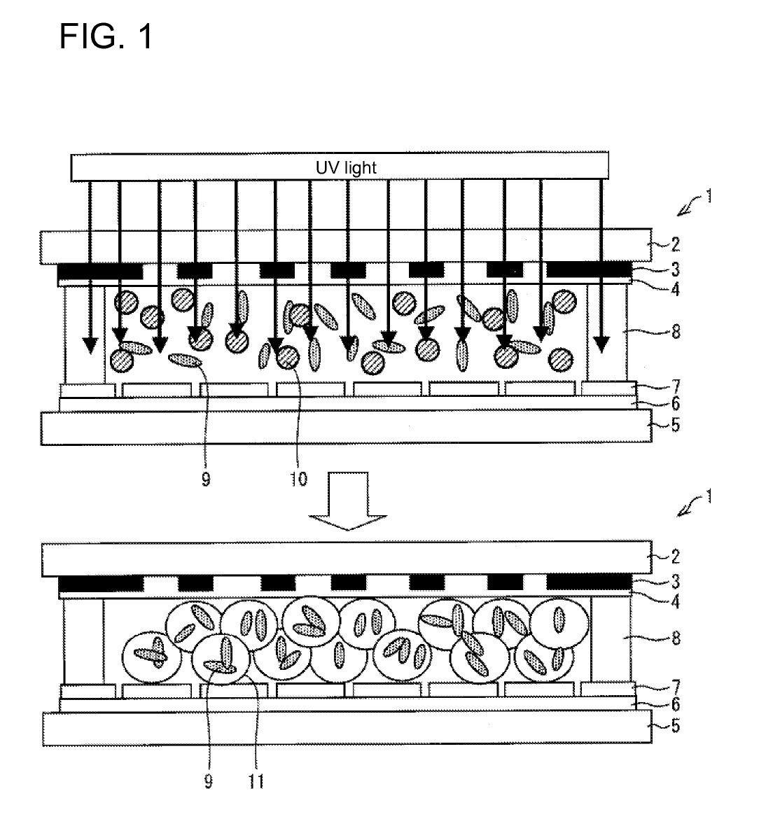

Described below with reference to FIGS. 1 to 5 is a configuration of a reflective liquid crystal display panel 1 provided in a reflective light-scattering type liquid crystal display device that is an example of a liquid crystal display device of the present invention.

FIG. 1 shows a schematic configuration of the liquid crystal display panel 1 and a curing process of a light-scattering type liquid crystal material, which contains monomer mixtures 10 that are curable by UV light (ultraviolet light) irradiation, included in the liquid crystal display panel 1.

The liquid crystal display panel 1 is provided with an opposite substrate 2 (transparent insulating substrate, a first or second insulating substrate) and a TFT array substrate 5 (insulating substrate, a first or second insulating substrate). A light-shielding film 3 (light-shielding body) that transmits UV light, which will be described later in detail, is formed on a surface of the opposite substrate 2 facing the TFT array substrate 5 (facing surface side), and a common electrode 4 made of a transparent conductive material such as ITO (Indium Tin Oxide) or IZO (Indium Zinc Oxide) is formed on an almost entire surface of the light-shielding film 3.

Meanwhile, a TFT element layer 6 in which a gate electrode, a gate insulating layer, a semiconductor layer, and a source/drain electrode layer are sequentially laminated is formed on a surface of the TFT array substrate 5 facing the opposite substrate 2.

On the TFT element layer 6, a pixel electrode 7, which is electrically connected to the drain electrode of the TFT element layer 6 and which is made of a transparent conductive material such as ITO or IZO, is formed in every pixel.

Here, the reflective liquid crystal display panel 1 of the present embodiment has a configuration in which a reflective member (reflective plate) is formed through the insulating layer although this reflective member is not illustrated on the TFT element layer 6, and therefore, the luminance or the like of the liquid crystal display panel is not affected by the size of an area where the TFT elements are formed in the TFT element layer 6 like a transmissive liquid crystal display panel.

That is, TFT elements for controlling image signal voltage to be applied to the pixel electrodes 7 are formed on a surface of the TFT array substrate 5 facing the opposite substrate 2.

Here, transparent glass substrates are used as the opposite substrate 2 and the TFT array substrate 5 in the present embodiment, but in the reflective liquid crystal display panel 1, the TFT array substrate 5 does not have to be a transparent substrate.

As shown in the figure, a sealing member 8 is formed in an outer periphery of the liquid crystal display panel 1, and the opposite substrate 2 and the TFT array substrate 5 provided in the liquid crystal display panel 1 are bonded together by the sealing member 8.

A light-scattering type liquid crystal material, which contains liquid crystal molecules 9 and the monomer mixtures 10 that are curable by UV light irradiation, is provided inside an area where the sealing member 8 is formed such that the light-scattering type liquid crystal material is sandwiched between the opposite substrate 2 and the TFT array substrate 5.

As illustrated in the figure, UV light irradiated from the side opposite to a surface of the opposite substrate 2 facing the TFT array substrate 5 sufficiently illuminates the above-mentioned light-scattering type liquid crystal material because the light-shielding film 3 transmits the UV light, and therefore, by adjusting an amount of the UV light, the monomer mixtures 10 contained in the light-scattering type liquid crystal material can be almost completely changed to polymers 11.

Consequently, because the uncured monomer mixtures 10 hardly exist in the above-mentioned light-scattering type liquid crystal material, display anomalies that are otherwise caused by the uncured monomer mixtures 10 do not occur even after a long term aging.

Here, it is possible to consider irradiating UV light from the side opposite to a surface of the TFT array substrate 5 facing the opposite substrate 2, however, in the liquid crystal display panel 1, the TFT element layer 6 that blocks the UV light range is formed on the TFT array substrate 5, and therefore, an area that is hardly irradiated with UV light would still be created when the UV light is irradiated from the side opposite to the surface of the TFT array substrate 5 facing the opposite substrate 2.

Moreover, a reflective member is formed on the TFT array substrate 5 side in the reflective liquid crystal display panel 1 although it is not shown in the figure, and therefore, it is difficult to radiate UV light from the TFT array substrate 5 side.

The above-mentioned reflective member is formed of a layer having high reflectance such as Al, for example, and it can be formed on a surface of the TFT array substrate 5 facing the opposite substrate 2 or on the surface on the opposite side. Here, the reflective member is not limited to such, and it is also possible to form a layer having high reflectance on a film, and to attach this film to the TFT array substrate 5 to form the reflective member.

In the case shown in FIG. 1, it is necessary to radiate UV light from the side opposite to a surface of the opposite substrate 2 facing the TFT array substrate 5, and when the light-shielding film 3 is formed on the opposite substrate 2 for improving the appearance and contrast, the light-shielding film 3 needs to have the characteristics to transmit UV light.

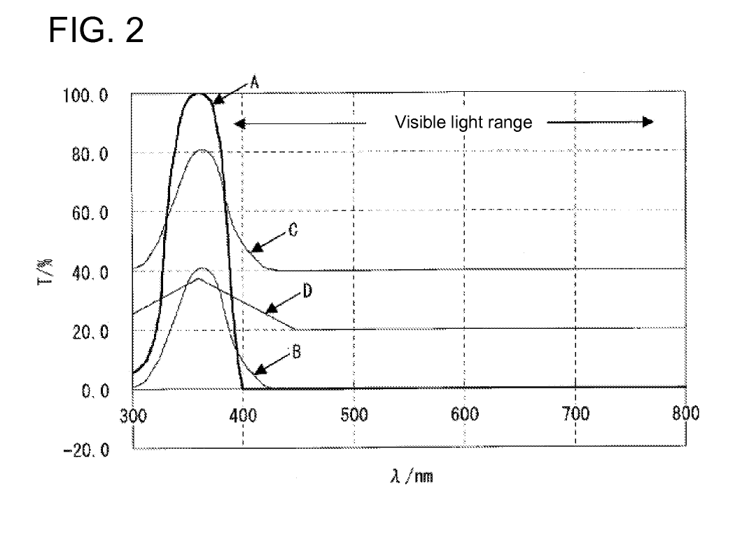

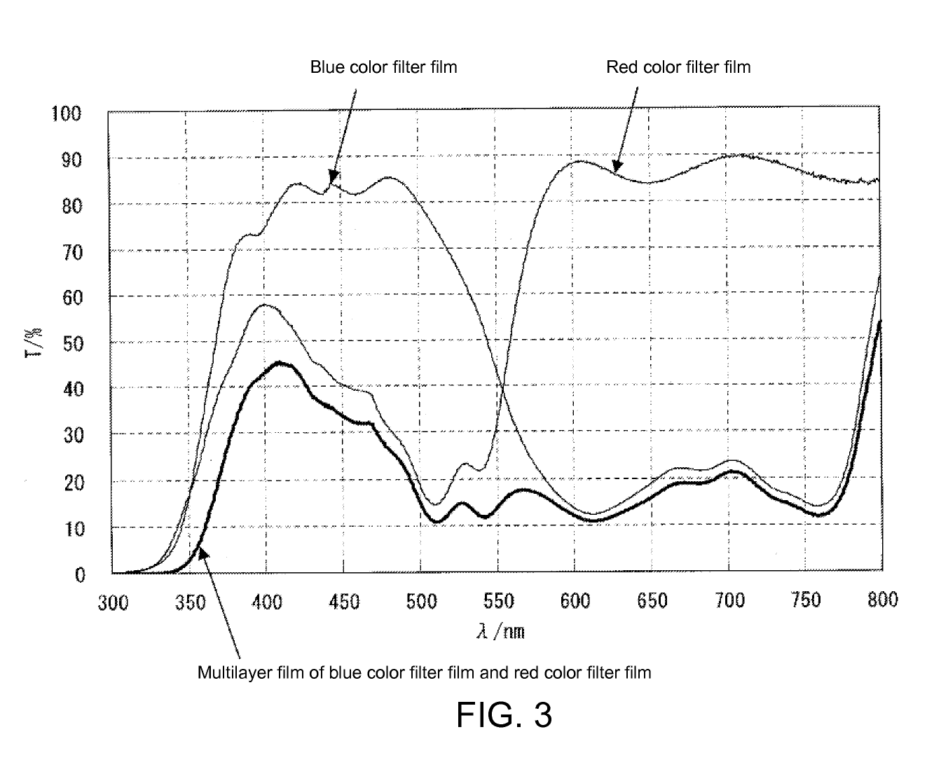

The light-shielding film 3 provided in the liquid crystal display panel 1 will be described below in detail with reference to FIGS. 2 and 3.

FIG. 2 shows a transmittance in the UV light range and a transmittance in the visible light range of an ideal light-shielding film and those of an actual light-shielding film.

In order to completely change the monomer mixtures 10 contained in the above-mentioned light-scattering type liquid crystal material into the polymers 11 and to suppress leakage of visible light in a non-display region of the liquid crystal display panel 1, it is ideal to use a light-shielding film that shows almost no transmittance in the visible light range and high transmitting characteristics in a wavelength range of 350 to 380 nm in the UV light range as shown by the line A in FIG. 2.

However, in an actual light-shielding film, when a transmittance in the visible light range is reduced to almost none, a transmittance in the UV light range is also decreased as shown by the line B in FIG. 2.

The line C in FIG. 2 shows an example of the light-shielding film 3 that can be used in a reflective light-scattering type liquid crystal display device.

As shown in the figure, the line C in FIG. 2 indicates that the peak value of the transmittance in the UV light range is 80% and the transmittance in the visible light range is 40%.

The line D in FIG. 2 shows a transmittance in the visible light range when the light-shielding film 3 having the transmitting characteristics indicated by the line C of FIG. 2 is used in a reflective light-scattering type liquid crystal display device.

In the case of a reflective light-scattering type liquid crystal display device, visible light passes through the light-shielding film 3 twice, and therefore, when using a light-shielding film that transmits 40% of visible light (60% blocked) indicated by the line C in FIG. 2, 40% of the visible light transmits through in the first time (at incidence) (60% blocked), and in the second time (at emission), with an accumulation from the first time, 16% of the visible light transmits through (84% blocked), and consequently, 80% or more of light in the visible light range can be blocked.

In other words, UV light is used for changing the monomer mixtures 10 contained in the light-scattering type liquid crystal material to the polymers 11 after passing through the light-shielding film 3 once, but visible light is emitted from the liquid crystal display panel after passing through the light-shielding film 3 twice, and therefore, an amount of the visible light to be emitted can be further suppressed.

FIG. 3 shows an example of the light-shielding film 3 provided in the liquid crystal display panel 1.

As shown in the figure, a multilayered film of a red color filter film having the transmitting characteristics in the red range and a blue color filter film having the transmitting characteristics in the blue range is used as the light-shielding film 3 in the present embodiment.

As shown in the figure, when the transmittance of the opposite substrate 2 is defined as 100%, the above-mentioned multilayer film has a transmittance of 20% or more at a wavelength within a wavelength range of 350 nm or longer and shorter than 380 nm, and has a transmittance of 50% or less at all wavelengths within a wavelength range of 430 nm to 700 nm, and therefore, it is possible to use the multilayer film as the light-shielding film 3 for transmitting UV light of a certain wavelength.

Here, the above-mentioned red color filter film and the above-mentioned blue color filter film may be formed by using a colored resist that is a mixture of pigment dispersed solutions of various colors and a transparent photosensitive resin, which is used for forming a conventional color filter film, but it is not limited to such, and a dye-type may also be used.

The above-mentioned color filter film may be formed by a spin coating method, a slit coating method, an inkjet method or the like, but it is not limited to these.

A single layer film formed by a mixture of colored materials having a plurality of transmissive wavelength ranges may also be used as the light-shielding film 3. It is possible to use a single layer film formed by a mixed solution of a plurality of colored materials such as a red colored material having a plurality of transmissive wavelength ranges and a blue colored material having a plurality of transmissive wavelength ranges, for example.

According to this configuration, the light-shielding film 3 is made of a single layer film formed by a mixed solution of colored materials having a plurality of light-shielding (light reducing) wavelengths for visible light.

Therefore, it is relatively easy to form the light-shielding film 3 in the liquid crystal display panel 1.

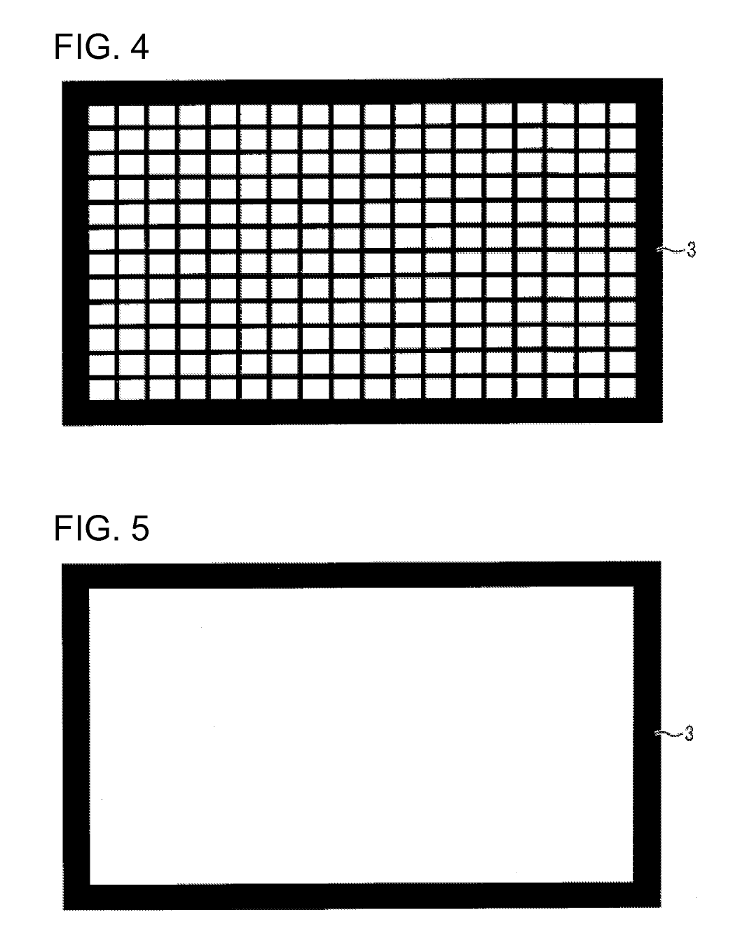

A shape of the light-shielding film 3 provided in the liquid crystal display panel 1 will be described below in detail with reference to FIGS. 4 to 5.

FIG. 4 shows an example of the shape of the light-shielding film 3 provided in the liquid crystal display panel 1.

The light-shielding film 3 shown in FIG. 4 has a shape for blocking light from entering a wiring portion, which is located at the periphery of each pixel and which is electrically connected to the gate electrode and the source/drain electrodes at the TFT element layer 6 formed on the TFT array substrate 5.

Because leakage of visible light from the above-mentioned wiring portion can be suppressed in this configuration, it is possible to achieve a liquid crystal display panel with improved contrast.

Further, because the light-shielding film 3 is formed at the frame portion area of the liquid crystal display panel 1, it is possible to improve the appearance and also to cover the sealing member area and wiring at the periphery.

According to the above-mentioned configuration, it is also possible to shield a flickering phenomenon at the periphery caused by interaction between the wiring at the periphery and the liquid crystal at the various.

In the present embodiment, a multilayer film of a red color filter film having the transmitting characteristics in the red range and a blue color filter film having the transmitting characteristics in the blue range is patterned to form the shape of the light-shielding film 3 shown in FIG. 4.

FIG. 5 shows an example of another shape of the light-shielding film 3.

The light-shielding film 3 shown in FIG. 4 has a shape in which the light-shielding film 3 is formed at the periphery of each pixel, and therefore, the amount of light transmitted at each pixel (when using a reflective liquid crystal display panel, the amount of reflected light to be transmitted) is decreased.

Accordingly, it is also possible to use a shape shown in FIG. 5 in which the light-shielding film 3 is only formed at the frame portion.

According to this configuration, it is possible to suppress a decrease in an amount of light transmitted at each pixel (when using a reflective liquid crystal display panel, an amount of reflected light to be transmitted).

A UV-curable sealing member that is curable by UV light irradiation is used as the sealing member 8 in the present embodiment.

When the UV-curable sealing member is used, takt time can be shortened as compared to when a heat-curable sealing member is used.

Also, the liquid crystal display panel 1 is provided with the light-shielding film 3 having the transmitting characteristics in the UV light range, and therefore, even when the sealing member 8 is disposed below an area where the light-shielding film 3 is formed, it is possible to sufficiently cure the sealing member 8 by irradiating UV light from the opposite substrate 2 side on which the light-shielding film 3 is formed.

In other words, because UV light can be radiated from the opposite substrate 2 side on which the light-shielding film 3 is formed and because the sealing member 8 can be sufficiently irradiated with the UV light, it is possible to cure the sealing member 8 without leaving an uncured component, and therefore, the liquid crystal display panel 1 capable of maintaining reliability for a long period of time can be achieved.

Here, because a conventional product can be used as is for the UV-curable sealing member, the detailed description will be omitted.

It is preferable that beads or the like for securing a distance between the opposite substrate 2 and the TFT array substrate 5 be included in the sealing member 8.

Moreover, it is preferable that acrylic monomers or acrylic oligomers that are polymerized and cured by UV light irradiation be contained in the monomer mixtures 10, but this is not a limitation. Any monomers and oligomers may be used as long as they are polymerized and cured by UV light irradiation and have the transparent characteristics after being cured.

The above-mentioned acrylic monomers may be 2-ethylhexyl acrylate, 2-hydroxyethel acrylate or the like, but they are not limited to these.

The acrylic oligomers may be polyester acrylate, epoxy acrylate, polyurethane acrylate or the like, but they are not limited to these.

A wavelength range of UV light that is necessary to polymerize and cure the above-mentioned acrylic monomers and acrylic oligomers is 350 to 380 nm, and therefore, it is preferable that the light-shielding body 3 have its highest value of a transmittance in a wavelength range of 350 to 380 nm.

Moreover, in view of shortening the time required for polymerization and curing, the monomer mixture 10 may contain polymerization initiators, chain transfer agents, photosensitizers, dyes, crosslinking agents, and the like.

Although not shown in the figure, it is also preferable that a color filter layer of red, green, and blue be formed on the opposite substrate 2 on which the light-shielding body 3 is formed, for example.

Here, the TFT array substrate 5 in which the TFT element layer 6 is formed is used in the present embodiment, however, it is not limited to such, and a substrate that is not provided with active elements such as TFTs may also be used.

Moreover, in the present embodiment, p-Si (polysilicon, polycrystalline silicon) is used for the semiconductor layer provided in the TFT element layer 6, and the gate driver and the source driver are monolithically fabricated.

Besides polysilicon, a-Si (amorphous silicon), CG silicon (Continuous Grain Silicon, continuous grain crystalline silicon) or the like may also be used for the above-mentioned semiconductor layer.

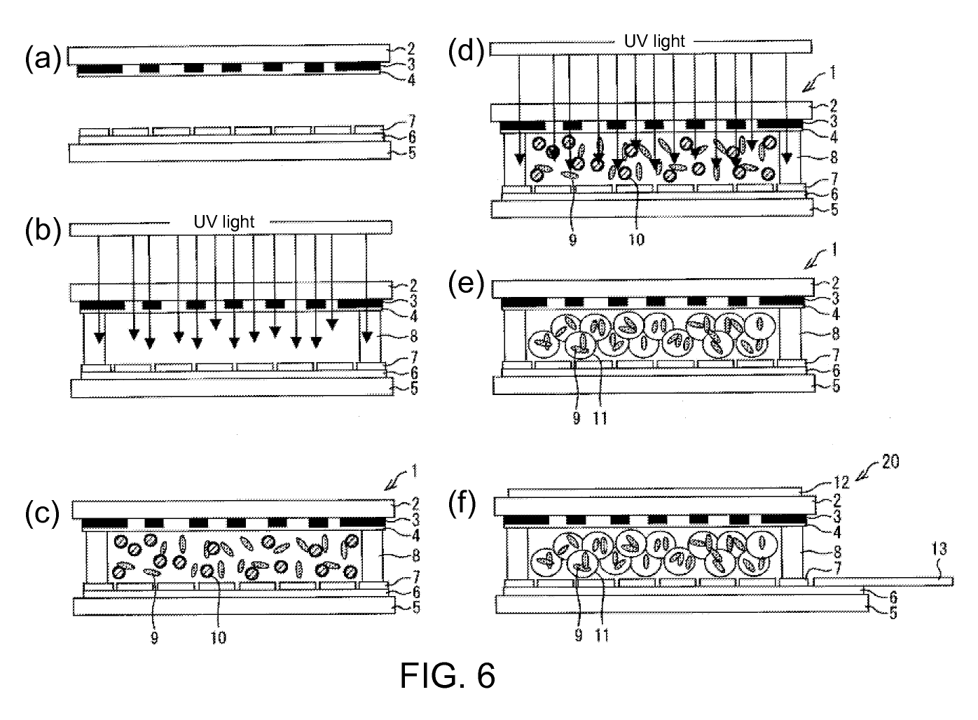

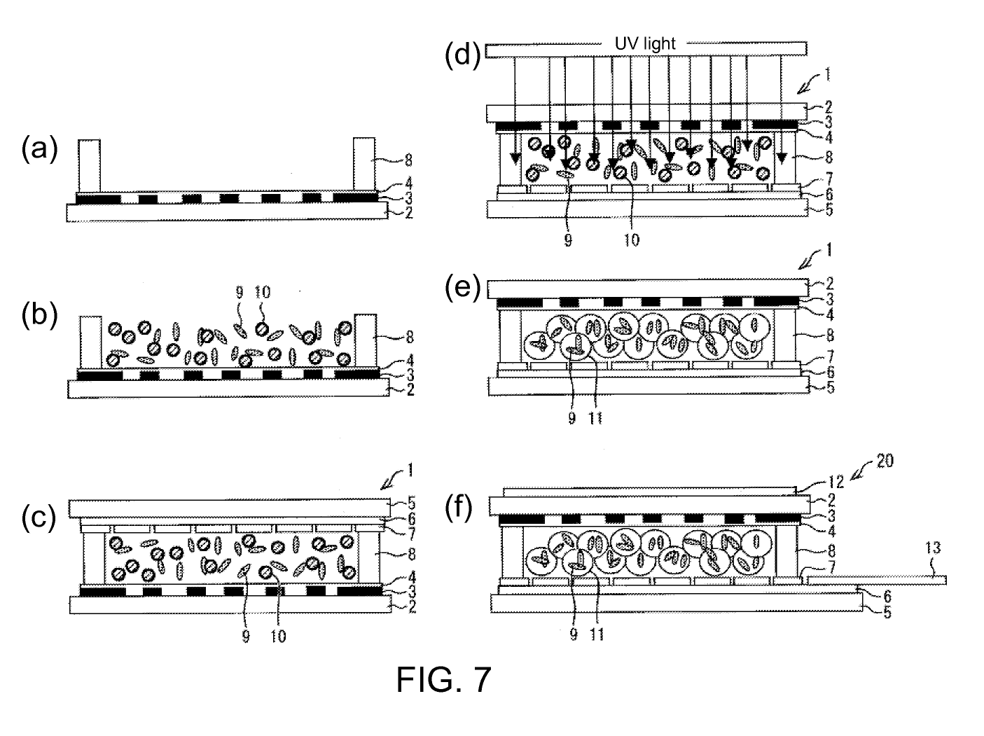

A process for manufacturing (method for manufacturing) the liquid crystal display panel 1 will be described below in detail with reference to FIGS. 6 and 7.

FIG. 6 is a diagram showing a process for manufacturing the liquid crystal display panel 1 in which a light-scattering type liquid crystal material is injected by vacuum injection.

As shown in FIG. 6(a) and FIG. 6(b), an alignment film (not shown in the figure) is respectively formed on a surface of the above-described opposite substrate 2 and a surface of the TFT array substrate 5 facing each other; the sealing member 8 is drawn at the edge area of the liquid crystal display panel 1; the opposite substrate 2 and the TFT array substrate 5 are bonded together; and the UV-curable sealing member 8 is irradiated with UV light to manufacture an empty panel without a light-scattering type liquid crystal material.

Here, a rubbing treatment does not need to be performed on the alignment films in the above-mentioned step.

An injection opening is formed at a part of the cured sealing member 8 in the above-mentioned empty panel.

The interior of the above-mentioned empty panel is vacuumed, and light-scattering type liquid crystal, which contains the liquid crystal molecules 9 and the monomer mixtures 10, is drawn to the empty panel through the above-mentioned injection opening. Therefore, the injection opening is sealed so that the liquid crystal display panel 1 shown in FIG. 6(c) is manufactured.

After that, as shown in FIG. 6(d), the monomer mixtures 10 are polymerized and cured by irradiating UV light from the opposite substrate 2 side on which the light-shielding film 3 is formed.

As already discussed above, an area below the area where the light-shielding film 3 is formed can be sufficiently irradiated with UV light because the light-shielding film 3 transmits UV light, and therefore, it is possible to manufacture a liquid crystal display panel 1 having a light-scattering type liquid crystal material in which nearly no uncured monomer mixture 10 is contained and in which the monomer mixtures 10 have been almost completely changed to the polymers 11, as shown in FIG. 6(e).

Then, as shown in FIG. 6(f), a UV cut filter 12 (ultraviolet cut filter) is formed on the side opposite to the surface of the opposite substrate 2 facing the TFT array substrate 5 for preventing the light-scattering type liquid crystal material that have become the polymers 11 from being decomposed by UV light, and a FPC 13 for inputting signals from outside is formed. As a result, a reflective liquid crystal display device 20 is manufactured.

FIG. 7 is a diagram showing a process for manufacturing the liquid crystal display panel 1 in which a light-scattering type liquid crystal material is injected by the One Drop Filling method (ODF method).

As shown in FIG. 7(a), after an alignment film (not shown in the figure) is formed on the above-described opposite substrate 2, the sealing member 8 is drawn at the edge area of the alignment film.

Here, a rubbing treatment does not need to be performed on the alignment film in the above-mentioned step.

Then, as shown in FIG. 7(b), a light-scattering type liquid crystal material containing the liquid crystal molecules 9 and the monomer mixtures 10 is dripped inside of an area where the sealing member 8 is formed so that a liquid crystal layer is created.

After that, as shown in FIG. 7(c), the opposite substrate 2 and the TFT array substrate 5 are bonded together in a vacuum chamber to create the liquid crystal display panel 1, and then, as shown in FIG. 7(d), UV light is radiated from the opposite substrate 2 side on which the light-shielding film 3 is formed to cure the monomer mixtures 10 and the sealing member 8 simultaneously.

Note that the steps in FIG. 7(e) and FIG. 7(f) are similar to the steps in FIG. 6(e) and FIG. 6(f), and therefore, the description of them will be omitted.

It is possible to substantially shorten the time for injecting liquid crystal by using the above-mentioned One Drop Filling method (ODF method), and therefore, the productivity of the liquid crystal display panel 1 can be improved significantly.

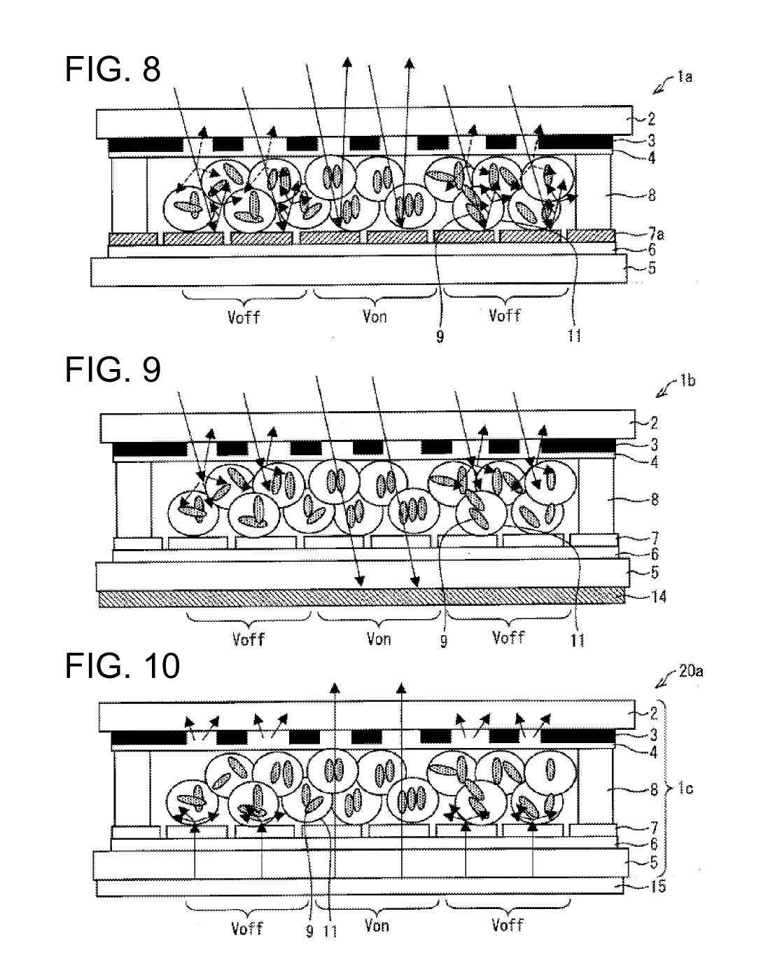

Modification examples of the liquid crystal display panel provided in a reflective liquid crystal display device will be described below with reference to FIGS. 8 and 9.

In a liquid crystal display panel 1a shown in FIG. 8, pixel electrodes 7a are made of Al or Ag, which are a conductive material having reflectivity (light reflective member).

In this configuration, in the Von region, the liquid crystal molecules 9 are all aligned in the direction in which voltage is applied. Therefore, almost no difference in refractive index occurs between the polymers 11 and the liquid crystal molecules 9. As a result, light is transmitted, reflected by the pixel electrodes 7a, and emitted as rectilinear light, thereby making the Von regions dark regions (minor state).

On the other hand, in the Voff regions, the liquid crystal molecules 9 are aligned randomly, and refractive index differences are generated between the polymers 11 and the liquid crystal molecules 9. As a result, light is scattered and reaches an observer, thereby making the Voff regions bright regions (white display).

Here, although not shown in the figure, the similar results will be obtained, as already discussed above, when a reflective member is formed on a surface of the TFT array substrate 5 opposite to a surface thereof facing the opposite substrate 2 in place of the pixel electrodes 7a.

In a liquid crystal display panel 1b shown in FIG. 9, a light absorption member 14, which absorbs light that has transmitted through the above-mentioned light-scattering type liquid crystal material, is formed on a surface of the TFT array substrate 5 opposite to a surface thereof facing the opposite substrate 2.

In this configuration, in the Von regions, the liquid crystal molecules 9 are aligned in the direction in which voltage is applied. Therefore, almost no difference in refractive index occurs between the polymers 11 and the liquid crystal molecules 9. As a result, light is transmitted and absorbed by the light absorption member 14, and therefore, the Von regions become dark regions.

On the other hand, in the Voff regions, the liquid crystal molecules 9 are aligned randomly. Therefore, a difference in refractive index occurs between the polymers 11 and the liquid crystal molecules 9. As a result, light is scattered, and thereby, the Voff regions become bright regions.

FIG. 10 shows a transmissive liquid crystal display device 20a provided with a liquid crystal display panel 1c.

The transmissive liquid crystal display device 20a shown in FIG. 10 includes the liquid crystal display panel 1c, which is different from the liquid crystal display panel 1 shown in FIG. 1 in that a reflective member is absent, and a backlight 15, which irradiates the liquid crystal display panel 1c evenly, is provided at the back of the liquid crystal display panel 1c.

In this configuration, in the Von regions, the liquid crystal molecules 9 are aligned in the direction in which voltage is applied. Therefore, almost no difference in refractive index occurs between the polymers 11 and the liquid crystal molecules 9. As a result, light from the backlight 15 is transmitted and emitted from gaps of the light-shielding film 3, thereby making the Von regions bright regions.

On the other hand, in the Voff regions, the liquid crystal molecules 9 are randomly aligned. Therefore, difference in refractive index occurs between the polymers 11 and the liquid crystal molecules 9. As a result, light from the backlight 15 is scattered, thereby making the Voff regions dark regions.

### Embodiment 2

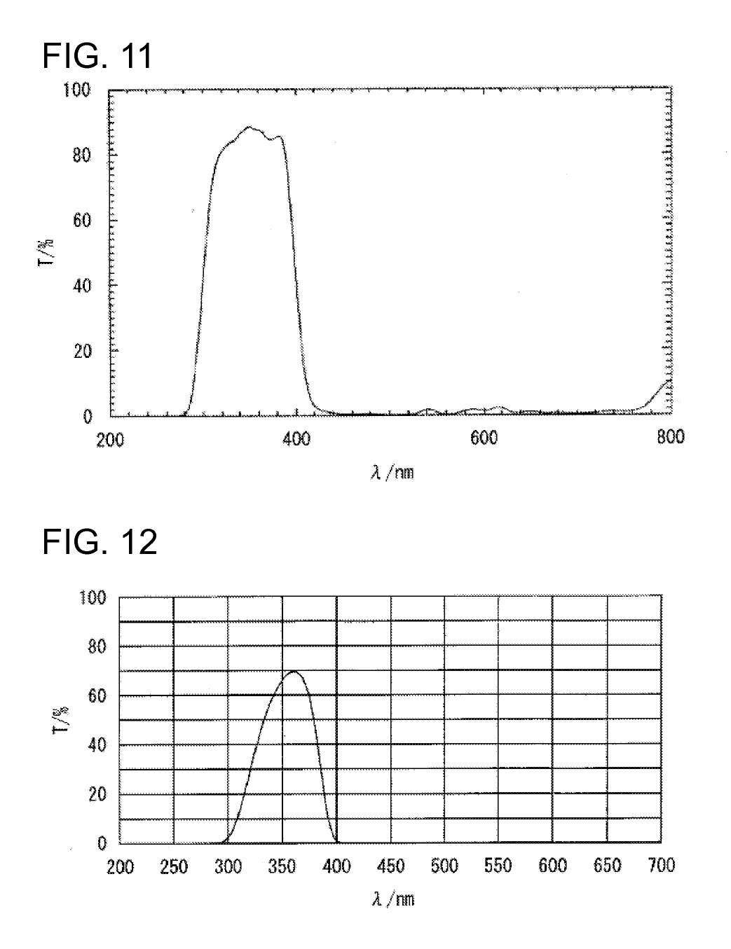

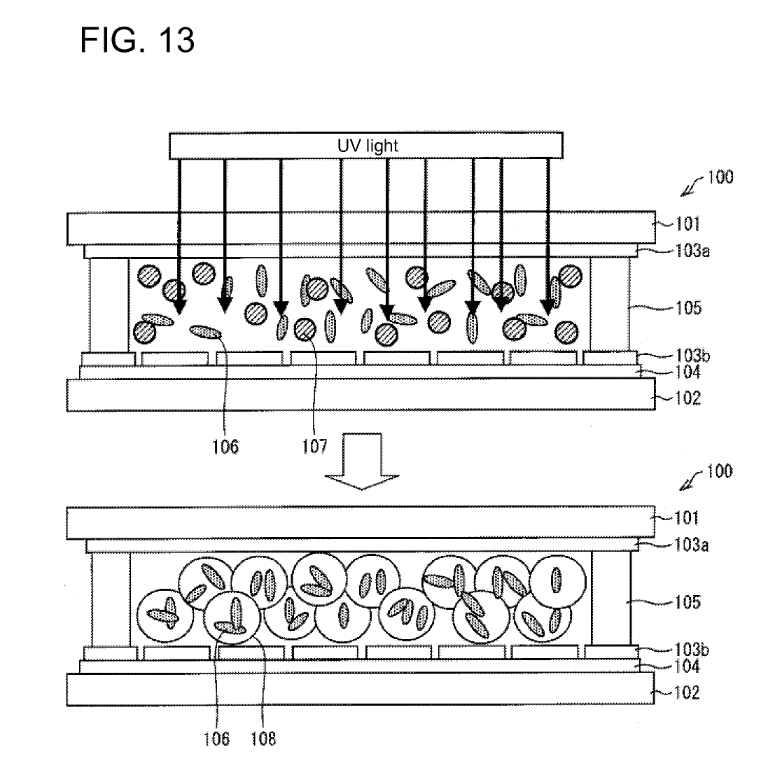

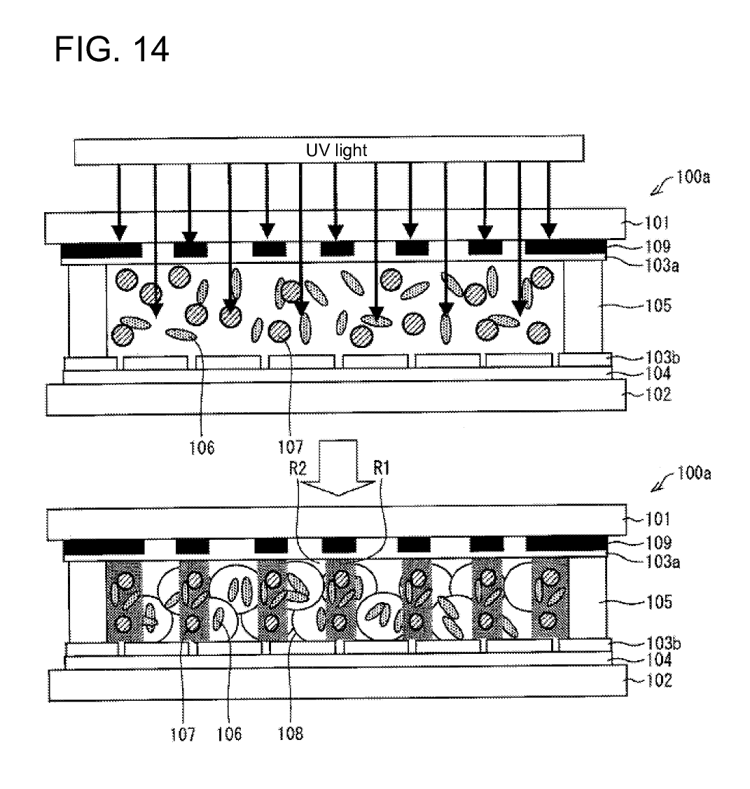

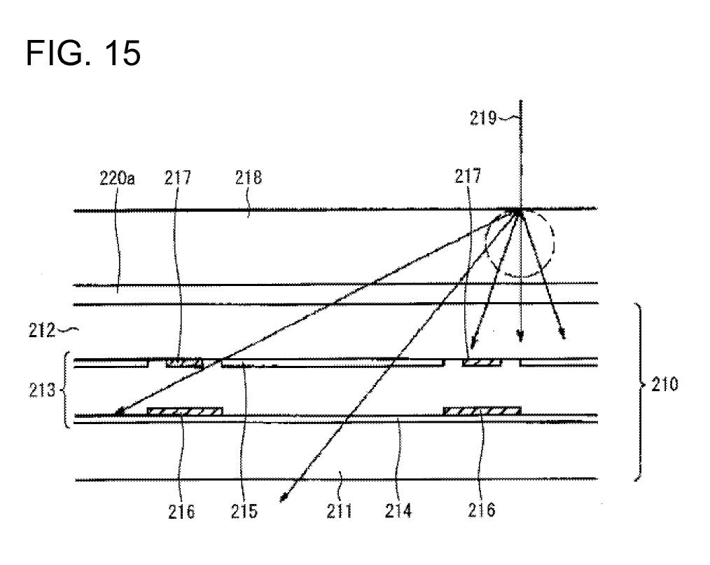

Next, Embodiment 2 of the present invention will be described with reference to FIG. 11. The present embodiment is different from Embodiment 1 in that the light-shielding film 3 is a dielectric multilayered film formed by vapor deposition, and the rest of the structures are same as those described in Embodiment 1. For convenience of description, the same reference characters are assigned to the members having the same function as the members shown in the figures of the above-mentioned Embodiment 1, and the description of them will be omitted.

FIG. 11 shows the transmittance in the UV light range and the transmittance in the visible light range of a dielectric multilayered film formed by the ECR sputtering method using electron cyclotron resonance plasma.

As shown in the figure, when the transmittance of the opposite substrate 2 is defined as 100%, the above-mentioned dielectric multilayered film has a transmittance of 20% or more at a wavelength within a wavelength range of 350 nm or longer and shorter than 380 nm, and has a transmittance of 50% or less at all wavelengths within a wavelength range of 430 to 700 nm, and therefore, it can be used as the light-shielding film 3 for transmitting UV light of a certain wavelength.

A metal multilayered film or the like may be used as the above-mentioned dielectric multilayered film, for example, and the dielectric multilayered film can be patterned by applying a resist onto the dielectric multilayered film and by performing a dry-etching thereon.

### Embodiment 3

Next, Embodiment 3 of the present invention will be described with reference to FIG. 12. The present embodiment is different from Embodiments 1 and 2 in that the light-shielding film 3 is an organic film containing NiO and Co₂O₃, and the rest of the structures are same as those described in Embodiment 1. For convenience of description, the same reference characters are attached to the members having the same function as the members shown in the figures of the above-mentioned Embodiment 1, and the description of them will be omitted.

FIG. 12 shows a transmittance in the UV light range and a transmittance in the visible light range of the organic film containing NiO and Co₂O₃.

As shown in the figure, when the transmittance of the opposite substrate 2 is defined as 100%, the above-mentioned organic film containing NiO and Co₂O₃ has a transmittance of 20% or more at a wavelength within a wavelength range of 350 nm or longer and shorter than 380 nm, and has a transmittance of 50% or less at all wavelengths within a wavelength range of 430 to 700 nm, and therefore, it can be used as the light-shielding film 3 for transmitting UV light of a certain wavelength.

Liquid in which NiO and Co₂O₃ are mixed with a transparent photosensitive resist made of an organic material is applied, exposed, and developed to obtain an organic film containing NiO and Co₂O₃ patterned in a desired shape.

In the above-mentioned configuration, NiO is a component that transmits ultraviolet light and that absorbs visible light, and Co₂O₃ is a component that absorbs visible light except for blue light panel. However, by adding Co₂O₃ to the above-mentioned NiO, light in a wavelength range of 405 to 700 nm can be absorbed effectively.

It is possible to further reduce the transmittance in the visible light range by using the above-mentioned organic film containing NiO and Co₂O₃ as the light-shielding film 3, and therefore, liquid crystal display panels 1, 1a, 1b, and 1c with further improved contrast can be achieved.

In a liquid crystal display panel of the present invention, it is preferable that the above-mentioned light-shielding body have its highest value of transmittance in a wavelength range of 350 nm or longer and shorter than 380 nm.

It is said that light in the above-mentioned wavelength range of 350 nm or longer and shorter than 380 nm is the light in the most effective wavelength range for curing the monomer mixture that is curable by UV light irradiation.

Accordingly, by providing a light-shielding body having its highest value of transmittance in a wavelength range of 350 nm or longer and shorter than 380 nm, even when UV light is irradiated from the insulating substrate side on which the above-mentioned light-shielding body is formed, it is possible to cure the above-mentioned monomer mixtures and the above-mentioned sealing member more effectively without leaving an uncured component. Therefore, a liquid crystal display panel that is capable of maintaining reliability for a long period of time can be achieved.

In a liquid crystal display panel of the present invention, it is preferable that the above-mentioned light-shielding body be a single layer film formed by a mixture of colored materials having a plurality of transmissive wavelength ranges.

A single layer film formed by a mixed solution of a plurality of colored materials such as a red colored material and a blue colored material may also be used as the above-mentioned light-shielding body, for example.

According to this configuration, the above-mentioned light-shielding body is made of a single layer film formed by a mixed solution of colored materials having a plurality of light-shielding (light reducing) wavelengths for visible light.

Therefore, it is relatively easy to form the above-mentioned light-shielding body in the above-mentioned liquid crystal display panel.

In a liquid crystal display panel of the present invention, it is preferable that a liquid crystal material sandwiched between the first insulating substrate and the second insulating substrate be composed of liquid crystal molecules and a monomer mixture, which is curable by irradiation of light in a wavelength range of 350 nm or longer and shorter than 380 nm.

According to this configuration, the above-mentioned liquid crystal material is composed of liquid crystal molecules and a monomer mixture that is curable by irradiation of light in a wavelength range of 350 nm or longer and shorter than 380 nm, which is a range the above-mentioned light-shielding body exhibits the transmitting characteristics, and therefore, even when the liquid crystal material is arranged below an area where the light-shielding body is formed, it is possible to sufficiently cure the monomer mixture by irradiating UV light from the insulating substrate side on which the light-shielding body is formed.

In other words, according to the above-mentioned configuration, UV light can be irradiated from the insulating substrate side on which the light-shielding body is formed, and the liquid crystal material can be sufficiently irradiated with light at a wavelength within a wavelength range of 350 nm or longer and shorter than 380 nm of the UV light, and therefore, it is possible to cure the liquid crystal material without leaving an uncured monomer mixture. Therefore, a liquid crystal display panel capable of maintaining reliability for a long period of time can be achieved.

In a liquid crystal display panel of the present invention, it is preferable that a sealing member for bonding the above-mentioned first and second insulating substrates be cured by irradiation of light in a wavelength range of 350 nm or longer and shorter than 380 nm.

According to the above-mentioned configuration, the above-mentioned sealing member is curable by irradiation of light in a wavelength range of 350 nm or longer and shorter than 380 nm, which is a range the above-mentioned light-shielding body exhibits transmitting characteristics, and therefore, even when the sealing member is arranged below the area where the light-shielding body is formed, it is possible to sufficiently cure the sealing member by radiating UV light from the insulating substrate side on which the light-shielding body is formed.

In other words, according to the above-mentioned configuration, UV light can be radiated from the insulating substrate side on which the light-shielding body is formed, and the above-mentioned sealing member can be sufficiently irradiated with light at a wavelength within a wavelength range of 350 nm or longer and shorter than 380 nm of the UV light, and therefore, it is possible to cure the sealing member without leaving an uncured component. Therefore, a liquid crystal display panel that is capable of maintaining reliability for a long period of time can be achieved.

In a liquid crystal display panel of the present invention, it is preferable that an active element for controlling image signal voltage and an pixel electrode that is electrically connected to the active element be formed on a substrate on which the above-mentioned light-shielding body is absent, which is either the first insulating substrate or the second insulating substrate, the active element and the pixel electrode being formed on a surface thereof facing the first insulating substrate or the second insulating substrate.

According to the above-mentioned configuration, an active element including a semiconductor layer, a metal layer or the like, which do not transmit UV light, is formed on a surface, facing the first insulating substrate or the second insulating substrate, of a substrate on which the above-mentioned light-shielding body is absent, which is either the first insulating substrate or the second insulating substrate. Therefore, even when UV light is radiated from the substrate side on which the light-shielding body is absent, which is either the first insulating substrate or the second insulating substrate, an area that is hardly irradiated with the UV light is still created.

Therefore, according the above-mentioned configuration, by providing a light-shielding body having the transmitting characteristics for light at a wavelength within a wavelength range of 350 nm or longer and shorter than 380 nm, even when UV light is radiated from the insulating substrate side on which the above-mentioned light-shielding body is formed, the UV light at the above-mentioned certain wavelength can transmit through the light-shielding body.

In a liquid crystal display panel of the present invention, it is preferable that a color filter layer be formed on a substrate on which the light-shielding body is formed, which is either the first insulating substrate or the second insulating substrate, the color filter layer being formed on a surface thereof facing the first insulating substrate or the second insulating substrate.

According to the above-mentioned configuration, it is possible to achieve a color liquid crystal display panel having a color filter layer on a surface, facing the first insulating substrate or the second insulating substrate, of a substrate on which the light-shielding body is formed, which is either the first insulating substrate or the second insulating substrate.

In a liquid crystal display panel of the present invention, it is preferable that a UV cut filter be formed on a substrate on which the light-shielding body is formed, which is either the first insulating substrate or the second insulating substrate, the UV cut filter being formed on a side opposite from a surface of the substrate facing the first insulating substrate or the second insulating substrate.

According to this configuration, by providing a UV cut filter after the monomer mixtures in the above-mentioned liquid crystal material and the sealing member have been cured by UV light irradiation, for example, it is possible to prevent the monomer mixtures in the liquid crystal material and the sealing member that have been cured by UV light irradiation from being decomposed by UV light.

In a liquid crystal display panel of the present invention, it is preferable that the above-mentioned light-shielding body be a multilayer film of a red color filter film and a blue color filter film.

According to this configuration, the above-mentioned light-shielding body is a multilayer film of a red color filter film and a blue color filter film, which is the color filter layer of the above-mentioned liquid crystal display panel.

Therefore, in a liquid crystal display panel provided with the color filter layer, the above-mentioned light-shielding body can be formed during the step of forming the red color filter film and the blue color filter film without adding a separate step of forming the light-shielding body.

Here, the red color filter film is a film having a transmittance in the red range of visible light, and the blue color filter film is a film having a transmittance in the blue range of visible light.

In a liquid crystal display panel of the present invention, it is preferable that the above-mentioned light-shielding body be an organic film containing NiO and Co₂O₃.

In this configuration, NiO is a component that transmits ultraviolet light and that absorbs visible light, and Co₂O₃ is a component that absorbs visible light except for blue light. However, by adding Co₂O₃ to the above-mentioned NiO, light in a wavelength range of 405 to 700 nm can be absorbed effectively.

Therefore, according to this configuration, an organic film that transmits UV light in the above-mentioned certain wavelength range and that absorbs visible light can be easily formed in the above-mentioned liquid crystal display panel.

In a liquid crystal display panel of the present invention, it is preferable that the above-mentioned light-shielding body be a dielectric multilayered film formed by vapor deposition.

According to this configuration, a dielectric multilayered film, which is the above-mentioned light-shielding body, can be easily formed by vapor deposition.

It is preferable that a method for manufacturing a liquid crystal display panel of the present invention include forming an active element for controlling image signal voltage and a pixel electrode, which is electrically connected to the active element, on a surface of the above-mentioned insulating substrate facing the above-mentioned transparent insulating substrate.

According to this method, active elements including a semiconductor layer, a metal layer or the like, which do not transmit UV light, are formed on a surface of the above-mentioned insulating substrate facing the above-mentioned transparent insulating substrate, and therefore, even when UV light is radiated from the above-mentioned insulating substrate side, an area that is hardly irradiated with UV light is created.

By providing a light-shielding body that has the transmitting characteristics for light at a wavelength within a wavelength range of 350 nm or longer and shorter than 380 nm, even when UV light is radiated from the transparent insulating substrate side on which the light-shielding body is formed, UV light of the above-mentioned certain wavelength can transmit through the light-shielding body.

The present invention is not limited to the respective embodiments described above. Various modifications can be made within the scope defined by the claims, and embodiments that can be obtained by appropriately combining technological features disclosed in different embodiments are also included in the technological scope of the present invention.

### INDUSTRIAL APPLICABILITY

The present invention can be used for liquid crystal display panels, for a method for manufacturing the liquid crystal display panels, and for liquid crystal display devices.

### DESCRIPTION OF REFERENCE CHARACTERS

1, 1a, 1b, 1c liquid crystal display panel

2 opposite substrate (transparent insulating substrate, first or second insulating substrate)

3 light-shielding film (light-shielding body)

5 TFT array substrate (insulating substrate, first or second insulating substrate)

6 TFT element layer (active element)

7 pixel electrode

8 sealing member

9 liquid crystal molecule

10 monomer mixture

11 polymer

12 UV cut filter (ultraviolet cut filter)

20, 20a liquid crystal display device

1. A liquid crystal display panel, comprising:
a first insulating substrate;
a second insulating substrate disposed so as to face said first insulating substrate; and
a light-shielding body that blocks light from entering at least a part of a non-display region of said liquid crystal display panel, the light-shielding body being formed on a surface of either said first insulating substrate or said second insulating substrate that faces the other one of said first insulating substrate and said second insulating substrate,
wherein at least an insulating substrate on which said light-shielding body is formed, which is either said first insulating substrate or said second insulating substrate, is a transparent insulating substrate, and
wherein when a transmittance of said transparent insulating substrate is defined as 100%, said light-shielding body has a transmittance of 20% or more at a wavelength within a wavelength range of 350 nm and longer and shorter than 380 nm, and said light-shielding body has a transmittance of 50% or less at all wavelengths in a wavelength range of 430 nm and longer and 700 nm and shorter.

2. The liquid crystal display panel according to claim 1, wherein said light-shielding body has its highest value of transmittance in a wavelength range of 350 nm and longer and shorter than 380 nm.

3. The liquid crystal display panel according to claim 1, wherein said light-shielding body is a single layer film formed of a mixture of colored materials having a plurality of transmissive wavelength ranges.

4. The liquid crystal display panel according to claim 1, wherein a liquid crystal material sandwiched between said first insulating substrate and said second insulating substrate comprises liquid crystal molecules and a monomer mixture that is cured by irradiation of light in a wavelength range of 350 nm or longer and shorter than 380 nm.

5. The liquid crystal display panel according to claim 1, wherein a sealing member for bonding said first insulating substrate and said second insulating substrate is cured by irradiation of light in a wavelength range of 350 nm or longer and shorter than 380 nm.

6. The liquid crystal display panel according to claim 1, wherein an active element for controlling image signal voltage and a pixel electrode that is electrically connected to said active element are formed on a substrate on which said light-shielding body is absent, which is either said first insulating substrate or said second insulating substrate, the active element and the pixel electrode being formed on a surface thereof facing said first insulating substrate or said second insulating substrate.

7. The liquid crystal display panel according to claim 1, wherein a color filter layer is formed on a substrate on which said light-shielding body is formed, which is either said first insulating substrate or said second insulating substrate, the color filter layer being formed on a surface thereof facing said first insulating substrate or said second insulating substrate.

8. A liquid crystal display device, comprising:
the liquid crystal display panel according to claim 1, wherein a substrate on which said light-shielding body is absent is also a transparent insulating substrate; and
a backlight for irradiating said liquid crystal display panel with light.

9. A liquid crystal display device, comprising the liquid crystal display panel according to claim 1, wherein a light reflective member for reflecting light or a light absorption member for absorbing light is formed on a substrate on which said light-shielding body is absent, which is either said first insulating substrate or said second insulating substrate.

10. The liquid crystal display panel according to claim 1, further comprising a UV cut filter formed on a substrate on which said light-shielding body is formed, which is either said first insulating substrate or said second insulating substrate, the UV cut filter being formed on a side opposite from a surface of the substrate facing said first insulating substrate or said second insulating substrate.

11. The liquid crystal display panel according to claim 1, wherein said light-shielding body is a multilayer film of a red color filter film and a blue color filter film.

12. The liquid crystal display panel according to claim 1, wherein said light-shielding body is an organic film containing NiO and Co₂O₃.

13. The liquid crystal display panel according to claim 1, wherein said light-shielding body is a conductive multilayer film formed by vapor deposition.

14. A method for manufacturing a liquid crystal display panel that includes:
a transparent insulating substrate;
an insulating substrate disposed so as to face said transparent insulating substrate;
a sealing member for bonding said transparent insulating substrate and said insulating substrate; and
a liquid crystal material,
the method comprising:
forming a light-shielding body on a surface of said transparent insulating substrate facing said insulating substrate, the light-shielding body blocking light from entering at least a part of a non-display region of said liquid crystal display panel, wherein when a transmittance of said transparent insulating substrate is defined as 100%, the light-shielding body has a transmittance of 20% or more at a wavelength within a wavelength range of 350 nm and longer and shorter than 380 nm, and a transmittance of 50% or less at all wavelengths within a wavelength range of 430 nm and longer and 700 nm and shorter;
forming said sealing member, which is cured by irradiation of light at a wavelength range of 350 nm or longer and shorter than 380 nm, on a surface of said transparent insulating substrate facing said insulating substrate, or on a surface of said insulating substrate facing said transparent insulating substrate;
dripping said liquid crystal material, which contains a monomer mixture that is cured by irradiation of light at a wavelength range of 350 nm or longer and shorter than 380 nm, in an area enclosed by said sealing member on a surface on which said sealing member is formed;
bonding said transparent insulating substrate and said insulating substrate together; and
irradiating said liquid crystal material and sealing member with UV light through said transparent insulating substrate from a side opposite to a surface of said transparent insulating substrate facing said insulating substrate.

15. A method for manufacturing a liquid crystal display panel that includes:
a transparent insulating substrate;
an insulating substrate disposed so as to face said transparent insulating substrate;
a sealing member for bonding said transparent insulating substrate and said insulating substrate; and
a liquid crystal material,
the method comprising:
forming a light-shielding body on a surface of said transparent insulating substrate facing said insulating substrate, the light-shielding body blocking light from entering at least a part of a non-display region of said liquid crystal display panel, wherein when a transmittance of said transparent insulating substrate is defined as 100%, it has a transmittance of 20% or more at a wavelength within a wavelength range of 350 nm and longer and shorter than 380 nm, and a transmittance of 50% or less at all wavelengths within a wavelength range of 430 nm and longer and 700 nm and shorter;
forming said sealing member on a surface of said transparent insulating substrate facing said insulating substrate, or on a surface of said insulating substrate facing said transparent insulating substrate, and then bonding said transparent insulating substrate and said insulating substrate together;
injecting said liquid crystal material, which contains a monomer mixture that is cured by irradiation of light in a wavelength range of 350 nm or longer and shorter than 380 nm, between said transparent insulating substrate and said insulating substrate that have been bonded; and
irradiating said liquid crystal material with UV light through said transparent insulating substrate from a side opposite to a surface of said transparent insulating substrate facing said insulating substrate.

16. The method for manufacturing a liquid crystal display panel according to claim 14, further comprising forming an active element for controlling image signal voltage and a pixel electrode that is electrically connected to said active element on a surface of said insulating substrate that faces said transparent insulating substrate.
